(19) United States
(12) Patent Application Publication
(10) Pub. No.: US 2014/0250679 A1
(43) Pub. Date: Sep. 11, 2014

(54) OPTICAL INSPECTION APPARATUS AND OPTICAL INSPECTION SYSTEM

(71) Applicant: CANON KABUSHIKI KAISHA, Tokyo (JP)

(72) Inventors: Masayuki Nishiwaki, Yoshikawa-shi (JP); Hiroshi Haruyama, Yokohama-shi (JP)

(73) Assignee: CANON KABUSHIKI KAISHA, Tokyo (JP)

(21) Appl. No.: 14/197,349

(22) Filed: Mar. 5, 2014

(30) Foreign Application Priority Data
Mar. 8, 2013 (JP) 2013-046250

(51) Int. Cl. G01N 21/94

(52) U.S. Cl. CPC G01N 21/94
USPC 29/593; 356/237.3

(57) ABSTRACT

An optical inspection apparatus inspecting the optical system of the optical scanning apparatus by measuring the light quantity of scanning light emitted from the optical scanning apparatus includes: a slit plate that includes a plurality of slits for allowing a part of scanning light to pass provided so as to include a scanning effective portion; a diffuser that diffuses the scanning light having passed through slit; a light guide that guides the scanning light diffused by the diffuser; an optical sensor that measures the light quantity of the scanning light guided by the light guide; and an inspection device that inspects the state of the optical system by comparing a measurement result acquired by the optical sensor with a preset reference value, in which the slits are arranged at intervals in a direction where scanning is performed on the slit plate with the scanning light.

### BACKGROUND OF THE INVENTION

1. Field of the Invention

The present invention relates to an optical inspection apparatus and an optical inspection system that are for inspecting an optical system of an optical scanning apparatus.

2. Description of the Related Art

Conventionally, various methods have been developed that inspect presence or absence of dust intruded in an optical system, stains on optical elements (hereinafter, simply referred to as dust) in an optical scanning apparatus used for a digital copier, a laser printer or the like. One of the methods has been known that perform inspection by condensing laser light emitted from an optical scanning apparatus onto a movable slit plate provided on an image plane. One slit is arranged such that the longitudinal direction of an aperture of the slit is perpendicular to the optical scanning direction (see Japanese Patent Application Laid-Open No. 2003-240675). This inspection method measures the state of a beam spot passing through the slit based on variation in light quantity of the beam spot, and performs inspection for presence or absence of dust on the optical system of the optical scanning apparatus based on the state.

This inspection method moves a photo detection unit including one slit and one detection sensor in a scanning direction to a position on an image plane where inspection is required, receives laser light at the position, thus performing inspection. The photo detection unit is then sequentially moved to many inspection positions across the entire image plane, receives laser light at each inspection position to perform inspection, thereby allowing inspection across the entire image plane.

However, in the method of inspecting an optical scanning apparatus described in Japanese Patent Application Laid-Open No. 2003-240675, a photo detection unit is required to be sequentially moved to many inspection positions across an entire scanning range. Accordingly, the inspection requires a long time.

It is an object of the present invention to provide an optical inspection apparatus and an optical inspection system that can reduce inspection time for inspecting an optical system of an optical scanning apparatus.

### SUMMARY OF THE INVENTION

The present invention is an optical inspection apparatus inspecting an optical system of an optical scanning apparatus by measuring a light quantity of scanning light emitted from the optical scanning apparatus, including: a slit plate that has a plurality of slits; a diffuser that diffuses the scanning light having passed through the slit; a light guide that guides the scanning light diffused by the diffuser; an optical sensor that measures a light quantity of the scanning light guided by the light guide; and an inspection device that inspects a state of the optical system by comparing a measurement result acquired by the optical sensor with a preset reference value, in which the slits are arranged at intervals in a range including a scanning effective portion in a scanning range for the scanning light emitted from the optical scanning apparatus in a direction where scanning on the slit plate with the scanning light is performed.

An optical inspection system of the present invention includes: an optical scanning apparatus that includes a light source, and a rotary polygon mirror deflecting and reflecting light emitted from the light source as scanning light toward a slit plate; and the optical inspection apparatus.

Further features of the present invention will become apparent from the following description of exemplary embodiments with reference to the attached drawings.

### BRIEF DESCRIPTION OF THE DRAWINGS

FIGS. 1A and 1B are diagrams illustrating a schematic configuration of an optical inspection apparatus according to a first embodiment of the present invention. FIG. 1A is a plan view. FIG. 1B is a diagram illustrating a scanning effective portion.

FIG. 2 is a perspective view illustrating a photo detector of the optical inspection apparatus according to the first embodiment of the present invention.

FIGS. 3A and 3B illustrate the photo detector of the optical inspection apparatus according to the first embodiment of the present invention. FIG. 3A is a plan view. FIG. 3B is a cross-sectional view.

FIGS. 4A, 4B and 4C are graphs illustrating the spot light quantity, transmitted light quantity, and difference with different slit widths W in the case where the pitch P of the slits is larger than the spot diameter D. FIG. 4A illustrates the case where W/D=0.1. FIG. 4B illustrates the case where W/D=0.5. FIG. 4C illustrates the case where W/D=0.9.

FIG. 5 is a graph illustrating a relationship between the slit width ratio W/D and sensitivity in the case where the pitch P of slits is larger than the spot diameter D in the photo detector of the optical inspection apparatus according to the first embodiment of the present invention.

FIGS. 6A, 6B and 6C are graphs illustrating the spot light quantity, transmitted light quantity, and difference with different slit widths W in the case where the pitch P of slits is equivalent to the spot diameter D. FIG. 6A illustrates the case of W/D=0.1. FIG. 6B illustrates the case where W/D=0.5. FIG. 6C illustrates the case of W/D=0.9.

FIGS. 7A and 7B are graphs illustrating a relationship between the slit width ratio W/D and sensitivity. FIG. 7A illustrates the case where the pitch P is equivalent to the spot diameter D. FIG. 7B illustrates the case where the pitch P is equivalent to ½ of the spot diameter D.

FIGS. 8A, 8B, 8C and 8D illustrate variational examples of the photo detector of the optical inspection apparatus according to the first embodiment. FIG. 8A illustrates the case where the light guide is bent. FIG. 8B illustrates the case where the light guide has a substantially trapezoidal shape. FIG. 8C illustrates the case of where the light guide is bundle fibers. FIG. 8D illustrates the case where bundle fibers intervene between the slit plate and a diffuser.

FIG. 9 is a diagram illustrating a schematic configuration of an optical inspection system of a second embodiment of the present invention.

### DESCRIPTION OF THE EMBODIMENTS

Preferred embodiments of the present invention will now be described in detail in accordance with the accompanying drawings.

### First Embodiment

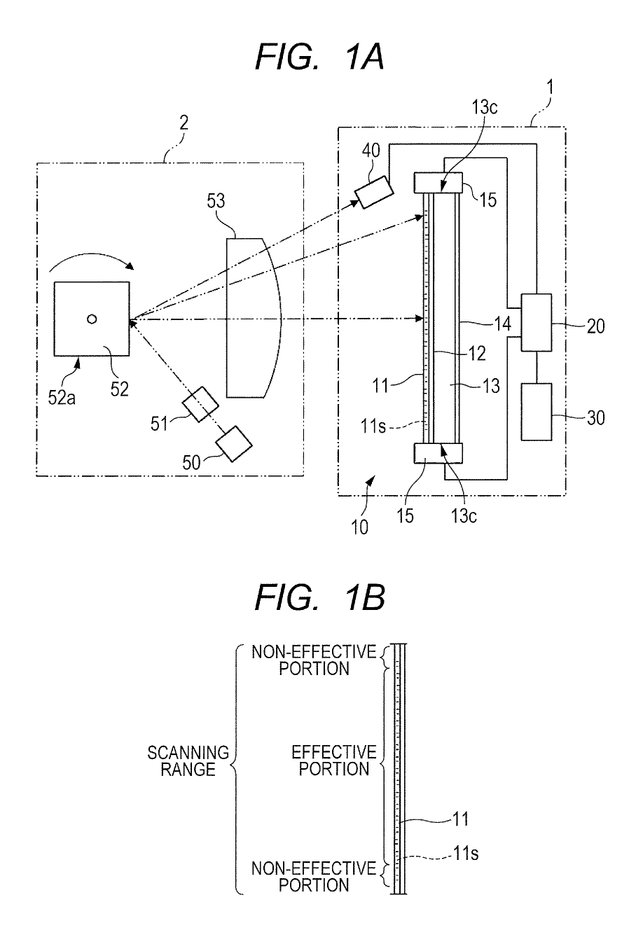

As illustrated in FIG. 1A, in this embodiment, an optical inspection apparatus 1 inspects an optical system of an optical scanning apparatus 2. The optical scanning apparatus 2, which is an inspection target, includes a laser light source (light source) 50. Laser light (emitted light) emitted from the laser light source 50 passes through a lens 51, by which the beam diameter is adjusted, and is condensed on a reflection surface 52a of a rotary polygon mirror 52. The rotary polygon mirror 52, which is arranged rotatable about the rotation axis, includes a plurality of reflection surfaces 52a, and is configured to rotate the reflection surfaces 52a about the rotation axis to thereby deflect and reflect the laser light while changing the reflection angle, and thus causes the light to enter an fθ lens 53. The laser light having passed through the fθ lens 53 is condensed (image-formed) on an image plane to form a beam spot S, and scanning is performed with the light on the image plane while the spot moves on this plane. The direction in which the beam spot S moves is called a scanning direction.

In conformity with a range where scanning is performed with light emitted from the optical scanning apparatus, there are an effective portion and a non-effective portion of the optical scanning apparatus. FIG. 1B illustrates this situation. The effective portion is a range where a laser beam printer including an optical scanning apparatus 2 scans the width of an area where an image is to be formed on a print target sheet. The rest are non-effective portions.

FIG. 1B illustrates correspondence between a scanning range of the beam spot S formed by the scanning light and a slit plate 11 included in the optical inspection apparatus 1 of the present invention.

The non-effective portions are areas other than the effective portion. There is, however, a case of causing light to enter a sensor that generates a start signal for writing an image. In this case, the corresponding range may be an effective portion.

Subsequently, a range including the effective portion and the non-effective portions may be called a scanning range. The effective portion in this range may be called a scanning effective portion.

The optical inspection apparatus 1 includes: a photo detector 10 that receives scanning light emitted from the optical scanning apparatus 2 and converts the light into an electric signal; an AD converter 20 that AD converts the electric signal; and an inspection device 30 that inspect a state of the optical system of the optical scanning apparatus 2 based on the AD converted signal. The optical inspection apparatus 1 includes a trigger photo detector 40 for detecting timing of scanning with the scanning light.

The laser light emitted from the optical scanning apparatus 2 is condensed on a surface of an after-mentioned slit plate 11 provided in the photo detector 10, the surface serving as an image plane; the slit plate 11 is scanned with this light, a part of which is caused to pass slits 11s formed on the slit plate 11. Optical sensors 15 provided in the photo detector 10 measure the light quantity of the scanning light having transmitted through the slits 11s, and output the volume to the AD converter 20.

Meanwhile, the trigger photo detector 40 is arranged upstream of the photo detector 10 in the scanning direction, one electric signal (trigger pulse) is emitted on each scan every time the rotary polygon mirror 52 rotates, and the signal is transmitted to the AD converter 20. The AD converter 20 AD converts the electric signal acquired by the photo detector 10 and sequentially outputs the signal to the inspection device 30 in a time-series manner, according to the trigger pulse emitted from the trigger photo detector 40 as a reference for measurement timing, for each scan with the laser light emitted from the optical scanning apparatus 2.

The inspection device 30 includes, for instance, a computer, and calculates the light quantity having transmitted through the slits 11s based on the electric signal, which is a measurement result acquired by the photo detector 10. The computer configuring the inspection device 30 includes, for instance, a CPU, a ROM that stores a program for calculating the light quantity having transmitted through the slits 11s based on the electric signal from the photo detector 10, a RAM that temporarily stores various pieces of data, and an input and output interface circuit.

The inspection device 30 adds signals acquired from the multiple optical sensors 15 via the AD converter 20, and calculates the maximum value of the light quantity, having transmitted through the slits 11s, at this point in time. As described later, the inspection device 30 determines presence or absence of dust in the optical system of the optical scanning apparatus 2 using variation in the maximum value of the transmitted light quantity.

The photo detector 10, which characterizes this embodiment, is hereinafter described in detail.

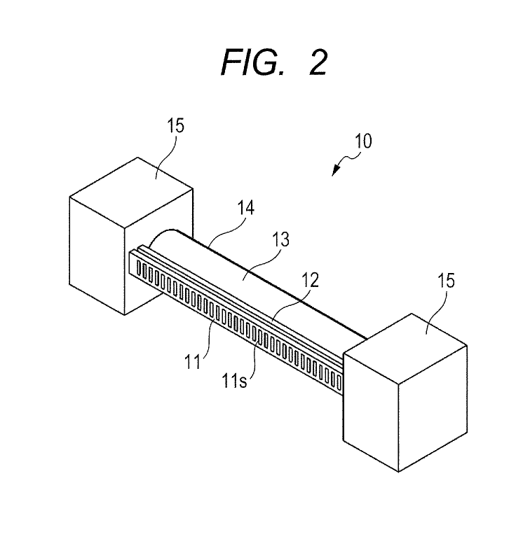

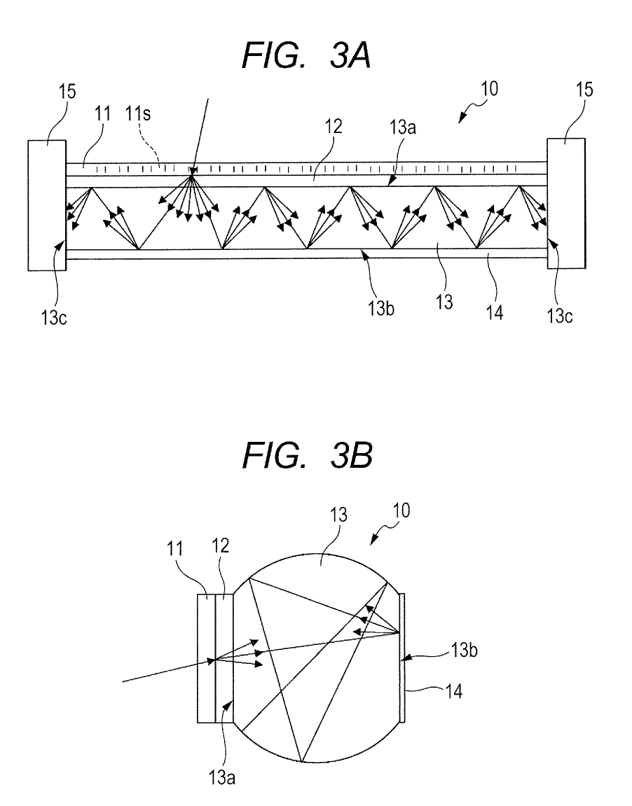

As illustrated in FIGS. 2, 3A and 3B, the photo detector 10 is fixed to the optical inspection apparatus 1, and includes the slit plate 11 having the multiple slits 11s through which scanning light passes. The slit plate 11 is made of a rectangular metal plate whose longitudinal direction coincides with the scanning direction. The slits 11s are light transmitting apertures that are formed on the slit plate 11, have a longitudinal direction orthogonal to the scanning direction, and are arranged at intervals along the scanning direction. In this embodiment, the size of the slit plate 11 covers the scanning range. The slits 11s are formed in the slit plate 11, at least across the effective portion (scanning effective portion) of the beam spot S. That is, the slits are arranged in a range covering the scanning effective portion in the scanning range of scanning light emitted from the optical scanning apparatus at intervals along the scanning direction of the scanning light on the slit plate.

The pitch P of arrangement of the slits 11s, and the aperture width (slit width) W of the slit 11s will be described later.

Here, the slit plate 11 is made of a metal plate, and the slits 11s are light transmitting apertures formed on the slit plate 11. Alternatively, for instance, the incident surface of an after-mentioned diffuser 12 may be masked with coating, and slits may be formed on respective parts of the surface by patterning.

The scanning light having passed through the slit 11s enters the diffuser 12 provided in contact with the back of the slit plate 11, and is diffused while passing through the diffuser 12. The diffuser 12 has a shape substantially identical to the shape of the slit plate 11, and made of opal glass here.

The scanning light diffused by the diffuser 12 enters the light guide 13 provided on the back of the diffuser 12, and is guided by the light guide 13 to end faces 13c. In this embodiment, the light guide 13 is made of an acrylic rod, which is a colorless transparent light transmitting member, and is arranged at the rearward of the diffuser 12 such that the longitudinal direction coincides with the scanning direction. The front side face of the light guide 13 is formed as a planar incident surface 13a. The diffuser 12 is arranged in contact with the incident surface 13a. Accordingly, the scanning light, having been diffused by and passed through the diffuser 12, enters the light guide 13 from the incident surface 13a.

The rear face of the light guide 13, that is, the surface opposite to the incident surface 13a, is formed as a planer reflection surface 13b. The diffusion film 14 is provided on the reflection surface 13b. The reflection surface 13b is a rough surface. The reflection surface 13b is coated with a white reflective material, thereby forming the diffusion film 14. Here, the diffusion film 14 is thus formed by finishing the reflection surface 13b of the light guide 13 as a rough surface and coating the film with the reflective material. The configuration is not limited thereto. Alternatively, for instance, the reflection surface 13b may be formed as a flat surface and coated with a reflective material, or a diffusive reflection member may be provided so as to be in contact.

The scanning light entering the light guide 13 from the incident surface 13a is diffused and totally reflected by the diffuser 12 and the diffusion film 14, and reaches the end faces 13c of the light guide 13.

Optical sensors 15 that measure the light quantity of the scanning light guided by the light guide 13 are provided at the respective end faces 13c of the light guide 13. For instance, any of photosensors, such as photodiodes and photomultiplier tubes, and known or new appropriate sensors may be adopted as the optical sensors 15. Electric signals acquired by the two optical sensors are input into the inspection device 30 via the AD converter 20, added to each other by the inspection device 30, and the light quantity having passed through the slits 11s are calculated.

Next, setting of the pitch P of the arrangement of the slits 11s and the slit width W is described.

First, if dust is in the optical system of the optical scanning apparatus 2, abnormality occurs in reflection and refraction, and the shape of the beam spot S is changed. As a result, even if the beam total energy does not vary and the light quantity of the entire spot light does not change, variation in spot diameter D in turn changes the light quantity having transmitted through the slits 11s or the maximum value of the transmitted light quantity. To inspect variation in the light quantity having transmitted through the slits 11s or the maximum value of the transmitted light quantity, it is required to appropriately set resolution and sensitivity for variation in light quantity. It is thus desired to appropriately set the pitch P and the slit width W.

The resolution here is an indicator corresponding to an inspectable position interval in the scanning direction. If the resolution is high, the position of dust can be highly accurately detected. The sensitivity here is an indicator corresponding to variation (in the spot diameter and the maximum light quantity at a center portion) of the beam spot S generated at dust. If the sensitivity is high, variation in the spot diameter D is sensitively reflected, thereby allowing smaller dust to be detected.

As to the resolution, the smaller the pitch P of arrangement of the slits 11s is, the higher the resolution of the scanning direction is. To inspect variation in the light quantity having passed through the slits 11s to locate the position of dust, a high resolution in the scanning direction is preferred. However, if the resolution is too high above what is required, processes of fabricating the slit plate 11 and inspection are complicated. An appropriate pitch P is set in conformity with a required resolution. For instance, in the case where the spot diameter D of the beam spot S is set to about 0.1 mm for detecting dust of about 25 μm in the optical system of the optical scanning apparatus 2, the pitch P is preferred to be set to 0.1 mm equivalent to the spot diameter D.

In this embodiment, the slits 11s are arranged at intervals in the direction where the slit plate 11 is scanned with the scanning light, in each pitch (prescribed unit for inspection) P equivalent to the spot diameter D. This arrangement achieves a resolution supporting the size of dust detectable by the spot diameter D.

Next, setting of the sensitivity is described.

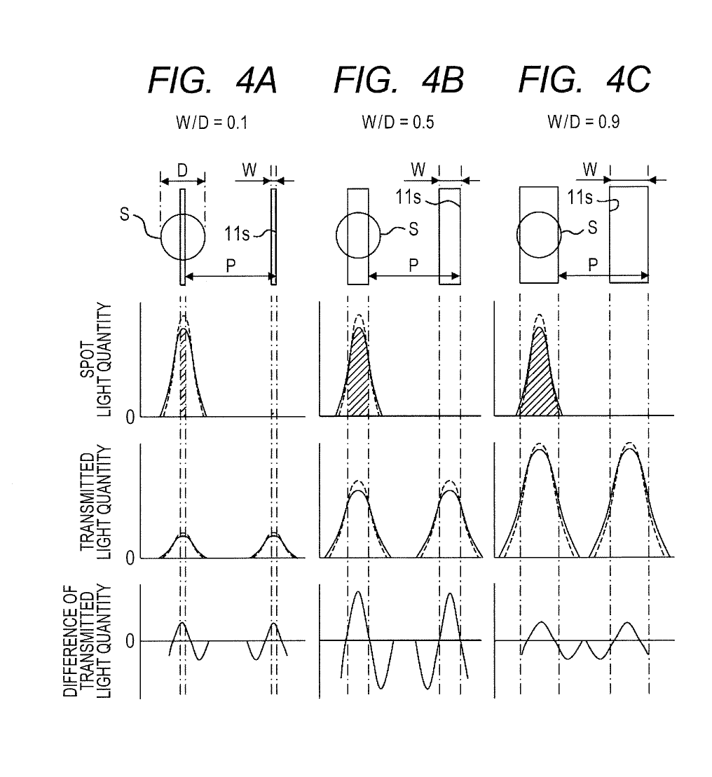

FIGS. 4A, 4B and 4C illustrate the relationship between the position of the beam spot S and the light quantity and difference in cases where the pitch P of the slits 11s is set larger than the spot diameter D to change the slit width ratio W/D to be three types, which are 0.1, 0.5 and 0.9. In these cases, the spot light passes through only one slit 11s, or an intervals between slits 11s are irradiated with the light, which does not pass through any slit 11s.

In the graphs of the spot light quantity in FIGS. 4A, 4B and 4C, the light quantity of the beam spot S in a case without dust (hereinafter, also called a normal case) is represented by solid lines. The light quantity of the beam spot S in a case with dust (hereinafter, also called an abnormal case) is represented by broken lines. Here, the beam profile of the beam spot S is of a Gaussian distribution. In some abnormal cases, the spot diameter D may be smaller than the diameter in the normal case even though the light quantity of the beam spot S is the same. Accordingly, the maximum light quantity at the spot center portion becomes large. In the graph of the spot light quantity in the abnormal case, the light quantity having passed through the slit 11s is represented by hatching.

In the examples illustrated in FIGS. 4A, 4B and 4C, at the center portion of the beam spot S, the light quantity in the abnormal case is higher than the volume in the normal case. Instead, at the peripheral portion of the beam spot S, the light quantity in the abnormal case is lower than the volume in the normal case.

In the graphs of transmitted light quantity in FIGS. 4A, 4B and 4C, the light quantities of the transmitted light in the normal cases are represented by solid lines, and the light quantities of the transmitted light in the abnormal cases are represented by broken lines. Furthermore, in the graphs of the difference of transmitted light quantities in FIGS. 4A to 4C, the difference between the transmitted light quantity in the normal case and the transmitted light quantity in the abnormal case is represented.

As illustrated in FIG. 4B, in the case where W/D=0.5, if the beam spot S is positioned at the center of the slit 11s, the light quantity in the abnormal case is higher than the light quantity in the normal case at almost all components of the transmitted light, the difference between the light quantity in the abnormal case and the volume of the light quantity in the normal case increases, and the difference increases in the positive direction. In the case where W/D=0.5, as the beam spot S moves apart from the center of the slit 11s, the light quantity of almost all components of the transmitted light in the abnormal case becomes lower than the light quantity in the normal case, the difference between the light quantity in the abnormal case and the volume in the normal case increases, and the difference becomes higher in the negative direction. Therefore, in the case where W/D=0.5 or therearound, scanning on the slit 11s with the beam spot S increases the difference (amplitude) between the maximum value and the minimum value of the differences of the light quantities in the abnormal case and the volumes in the normal case. Accordingly, variation in difference with respect to variation in spot becomes large, thereby achieving a high sensitivity.

As illustrated in FIG. 4A, in the case where W/D=0.1, when the beam spot S is positioned at the center of the slit 11s, the light quantity of almost all components of the transmitted light in the abnormal case becomes higher than the volume in the normal case. However, the slit 11s is narrower and the transmitted light quantity is lower than the slit and volume in the case where W/D=0.5.Accordingly, the difference between the light quantity in the abnormal case and the volume in the normal case becomes small. In the case where W/D=0.1, as the slit 11s of the beam spot S moves apart from the center, the light quantity of almost all components of the transmitted light in the abnormal case becomes lower than the volume in the normal case. However, since the transmitted light quantity is lower than the volume in the case where W/D=0.5, the difference between the light quantity in the abnormal case and the volume in the normal case becomes small. Accordingly, in the case where W/D=0.1 or therearound, scanning on the slit 11s with the beam spot S reduces the difference (amplitude) between the maximum value and the minimum value of differences between the light quantities in the abnormal case and the volumes in the normal case. Accordingly, variation in difference with respect to the variation in spot becomes small, thereby causing the sensitivity to be low.

As illustrated in FIG. 4C, in the case where W/D=0.9, when the beam spot S is positioned at the center of the slit 11s, the light quantity at the center portion of the beam spot S in the abnormal case is higher than the light quantity in the normal case. However, the light quantity in the peripheral portion of the beam spot S in the abnormal case is lower than the light quantity in the normal case. Accordingly, the light quantities are canceled, and the difference between the light quantity in the abnormal case and the light quantity in the normal case becomes small. In the case where W/D=0.9, as the beam spot S moves apart from the center of the slit 11s, the light quantity at the peripheral portion of the beam spot S in the abnormal case becomes lower than the light quantity in the normal case. However, the light quantity at the center portion of the beam spot S in the abnormal case becomes higher than the light quantity in the normal case. Accordingly, the light quantities are canceled, and the difference between the light quantity in the abnormal case and the light quantity in the normal case becomes small. Therefore, in the case where W/D=0.9 or therearound, scanning on the slit 11s with the beam spot S reduces the difference (amplitude) between the maximum value and the minimum value of the differences between the light quantity in the abnormal case and the light quantity of the normal case. Accordingly, variation in difference with respect to variation in spot is reduced, thereby causing the sensitivity to be low.

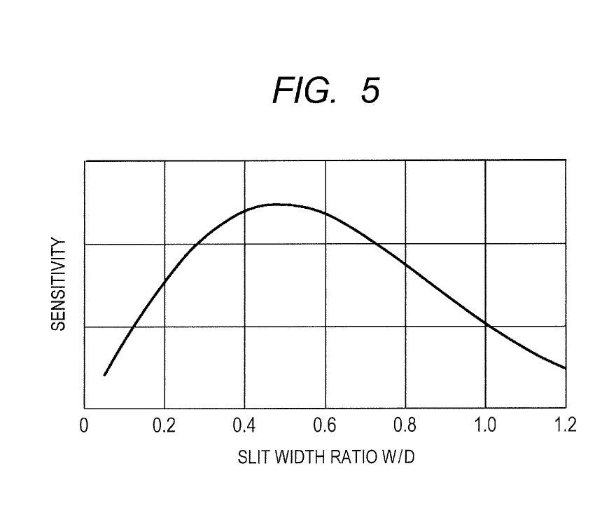

FIG. 5 illustrates a relationship between the slit width ratio W/D and sensitivity in the case where the forgoing pitch P of the slits 11s is larger than the spot diameter D. The sensitivity here is the difference (amplitude) between the maximum value and the minimum value of the transmitted light quantities in the case where the spot diameter D is changed by 10%. As illustrated in FIG. 5, as the slit width ratio W/D increases from 0, the sensitivity increases. As the slit width ratio W/D decreases from 1.2, the sensitivity increases.

As illustrated in FIG. 5, in the case where P>D, the sensitivity is significantly high in the following range.

0.3<W/D<0.7

(P: pitch of slit; W: slit width; D: spot diameter)

In the case where

W/D=0.5,

the sensitivity becomes the maximum.

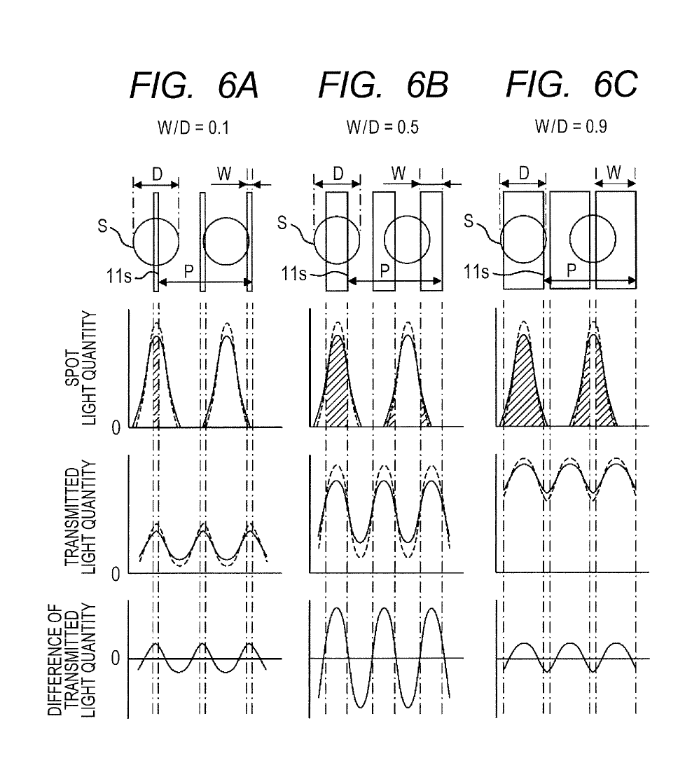

Next, FIGS. 6A, 6B and 6C illustrate the relationship between the position of the spot and the light quantity and difference in cases where the pitch P of the slits 11s is set identical to the spot diameter D and the slit width W is set to three types, which are W/D=0.1, 0.5 and 0.9. The details illustrated in each graph are equivalent to the details in FIGS. 4A to 4C. Accordingly, detailed description is omitted. In this case, the spot light passes through only one slit 11s or simultaneously passes through two slits 11s.

As illustrated in FIG. 6B, in the case where W/D=0.5, when the beam spot S is positioned at the center of the slit 11s (left in the diagram), the light quantity of almost all components of the transmitted light in the abnormal case is higher than the light quantity in the normal case. The difference between the light quantity in the abnormal case and the light quantity in the normal case increases; the difference increases in the positive direction. In the case where W/D=0.5, when the beam spot S is positioned at the center between slits 11s (right in the diagram), the light quantity of almost all components of the transmitted light in the abnormal case is lower than the light quantity in the normal case. The difference between the light quantity in the abnormal case and the light quantity in the normal case increases; the difference increases in the negative direction. Therefore, in the case where W/D=0.5 or therearound, scanning on the slit 11s with the beam spot S increases the difference (amplitude) between the maximum value and the minimum value of the light quantities in the abnormal case and the normal case. Accordingly, the variation in difference with respect to the variation in spot is large, thereby achieving a high sensitivity.

As illustrated in FIG. 6A, in the case where W/D=0.1, when the beam spot S is at the center of the slit 11s (left in the diagram), the light quantity of almost all components of the transmitted light in the abnormal case is higher than the normal case. However, the slit 11s is narrower and the transmitted light quantity is lower than the slit and volume in the case where the W/D=0.5. Accordingly, the difference between the light quantity in the abnormal case and the light quantity in the normal case decreases. In the case where W/D=0.1, when the beam spot S is at a center between slits 11s (right in the diagram), the light quantity of almost all components of the transmitted light in the abnormal case is lower than the light quantity in the normal case. However, the transmitted light quantity is lower than the volume in the case where W/D=0.5. Accordingly, the difference between the light quantity in the abnormal case and the light quantity in the normal case is small. Therefore, in the case where W/D=0.1 or therearound, scanning on slit 11s with the beam spot S reduces the difference (amplitude) between the maximum value and the minimum value of the light quantity in the abnormal case and the light quantity in the normal case. Accordingly, variation in difference with respect to the variation in spot is small, thereby causing the sensitivity to be low.

As illustrated in FIG. 6C, in the case where W/D=0.9, when the beam spot S is at the center of the slit 11s (left in the diagram), the light quantity of the center portion of the beam spot S in the abnormal case is higher than the light quantity in the normal case. However, the light quantity of the peripheral portion of the beam spot S in the abnormal case is lower than the light quantity in the normal case. Accordingly, the difference between the light quantity in the abnormal case and the light quantity in the normal case decreases. In the case where W/D=0.9, when the beam spot S is positioned at the center between slits 11s (right in the diagram), the light quantity of the peripheral portion of the beam spot S in the abnormal case is lower than the light quantity in the normal case. However, the light quantity in the center portion of the beam spot S is higher than the light quantity in the normal case. Accordingly, the difference of the light quantity in the abnormal case and the light quantity in the normal case decreases. Therefore, in the case where W/D=0.9 or therearound, scanning on the slit 11s with the beam spot reduces the difference (amplitude) between the maximum value and the minimum value of light quantities in the abnormal case and the normal case. Accordingly, variation in difference with respect to variation in spot is small, thereby causing the sensitivity to be low.

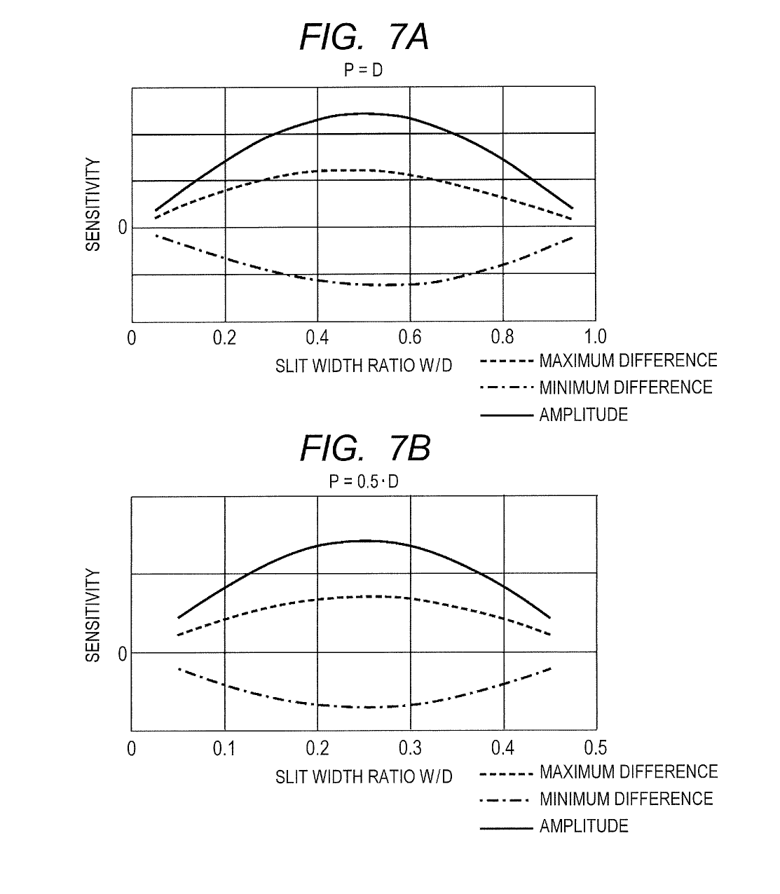

FIG. 7A illustrates the relationship between the slit width ratio W/D and the sensitivity in the case where the forgoing pitch P of the slits 11s is equivalent to the spot diameter D. The sensitivity here is the difference (amplitude) between the maximum difference and the minimum difference of the transmitted light quantities in the case where the transmitted light quantity varies by 10%. As illustrated in FIG. 7A, when the slit width ratio W/D is 0.5, the sensitivity is the maximum. As the slit width ratio W/D decreases below 0.5, the sensitivity decreases. As the slit width ratio W/D increases above 0.5, the sensitivity decreases.

Next, FIG. 7B illustrates the relationship between the slit width ratio W/D and the sensitivity in the case where the pitch P of the slits 11s is smaller than the spot diameter D. The method of drawing this graph is equivalent to the method in FIG. 7A. Here, P=0.5·D. The slit width ratio W/D ranges from 0 to 0.5. As illustrated in FIG. 7B, when the slit width ratio W/D is 0.25, the sensitivity is the maximum. As the slit width ratio W/D decreases below 0.25, the sensitivity decreases. As the slit width ratio W/D increases above 0.25, the sensitivity decreases.

Accordingly, as illustrated in FIGS. 7A and 7B, in the case where P≦D, in the range,

0.3<W/P<0.7

(P: pitch of slit; W: slit width; D: spot diameter),
the sensitivity is significantly high. In particular, when

W/P=0.5,

the sensitivity is the maximum.

Thus, as illustrated in FIGS. 5, 7A and 7B, the slit width W is set based on the pitch P and the spot diameter D and the required sensitivity. In this embodiment, P=D, and W/P=W/D 32 0.5. Note that it is a matter of course that the embodiment is not limited thereto.

The spot diameter D of the beam spot S formed by the optical scanning apparatus 2 is not even across the entire range in the scanning direction on the slit plate 11 but is different on each scanning position. Accordingly, the slit width W of the slit 11s can be different in conformity with each scanning position. For instance, in the case where the spot diameter D around an end of the slit plate 11 is larger than the spot diameter D around the center portion, the slit width W around the end of the slit plate 11 is set wider than the slit width W. Instead, for instance, in the case where the spot diameter D around the end of the slit plate 11 is smaller than the spot diameter D around the center portion, the slit width W around the end of the slit plate 11 is set narrower than the slit width W around the center portion. Thus, setting of the slit width W for each position in conformity with the spot diameter D can maintain the sensitivity constant with respect to variation in the spot diameter D in each scanning position.

Operations of the forgoing optical inspection apparatus 1 inspecting the optical system of the optical scanning apparatus 2 are described.

In the optical scanning apparatus 2, the laser light source 50 emits laser light. The laser light passes through the lens 51 with the beam diameter being adjusted, is condensed on the reflection surface 52a of the rotary polygon mirror 52, deflected and reflected, enters the fθ lens 53, and is condensed on the slit plate 11, thus performing scanning.

In the optical inspection apparatus 1, the laser light emitted from the optical scanning apparatus 2 enters the trigger photo detector 40 one time for each scan. A trigger pulse generated by the trigger photo detector 40 is input into the inspection device 30 via the AD converter 20. Based on time from the trigger pulse and the scanning speed, the slit through which the light has passed among the slits can be identified. Accordingly, the position at which dust exists in the optical system of the scanning direction can be identified.

In the optical inspection apparatus 1, the laser light emitted from the optical scanning apparatus 2, which is the inspection target, is condensed on the surface of the slit plate 11 as the image plane, thereby performing scanning on the slit plate 11; a part of the laser light passes through the slit 11s. The scanning light having passed through the slit 11s enters the diffuser 12 provided in contact with the back of the slit plate 11, diffused while passing through the diffuser 12, and enters the light guide 13 provided on the back of the diffuser 12. The scanning light having entered the light guide 13 is guided to the end faces 13c of the light guide 13 while being diffused and totally reflected by the diffuser 12 and the diffusion film 14, and input into the two optical sensors 15.

Each optical sensor 15 generates an electric signal according to the input light quantity. The signal is input into the inspection device 30 via the AD converter 20. The inspection device 30 adds the signals from the optical sensors 15 to each other, calculates the maximum value of the light quantity, having passed through the slits 11s, at this point in time, and stores the value as temporal data corresponding to laser light scanning. The inspection device 30 compares the maximum value of the light quantity having passed through the slit 11s with a preset prescribed reference value, and determines presence and absence of variation. Based on the result, presence and absence of variation in the spot diameter D of the spot light is inspected. If it is determined that the spot diameter D varies, it is determined that dust is on the optical system of the optical scanning apparatus 2, which is the inspection target, and estimates the position where the dust exists based on the position of the varying beam spot S.

As described above, according to the optical inspection apparatus 1 of this embodiment, the slit 11s are arranged across the entire the slit plate 11 at each prescribed pitch P in a range including the effective portion (scanning effective portion). Accordingly, in one scan with the spot light, the light can be received at multiple positions where the slit 11s are formed. Furthermore, the photo detector 10 is provided in a fixed manner, which negates the need of moving components in the photo detector 10. Accordingly, time required for inspection can be reduced in comparison with the case of moving the photo detection unit with a single slit for each scan and receiving light.

The optical inspection apparatus 1 of this embodiment includes the diffuser 12 between the slit plate 11 and the light guide 13. Accordingly, even in the case where the light incident on any of the slits 11s obliquely enters the slit plate 11, the light beam can be diffused by the diffuser 12 and enter the light guide 13. Accordingly, the volume of the light can be reduced that obliquely enters the slit plate 11, is reflected by the surface of the light guide 13 and cannot enter the light guide 13. The light quantity received by the optical sensor 15 can be increased.

According to the optical inspection apparatus 1 of this embodiment, the diffusion film 14 is provided on the surface of the light guide 13 opposite to the incident surface 13a. The scanning light having entered the light guide 13 is diffused and totally reflected by the diffuser 12 and the diffusion film 14, and reaches the end faces 13c of the light guide 13. Accordingly, the scanning light having entered the light guide 13 can be efficiently guided to the optical sensors 15, and the inspection accuracy can be improved.

According to the optical inspection apparatus 1 of this embodiment, the optical sensors 15 are provided at both the end of the light guide 13. The configuration is not limited thereto. Alternatively, an optical sensor 15 may be provided at only one end of the light guide 13, and a total reflection mirror may be provided at the other end. In this case, the number of optical sensors 15 can be reduced, which facilitates reduction in cost.

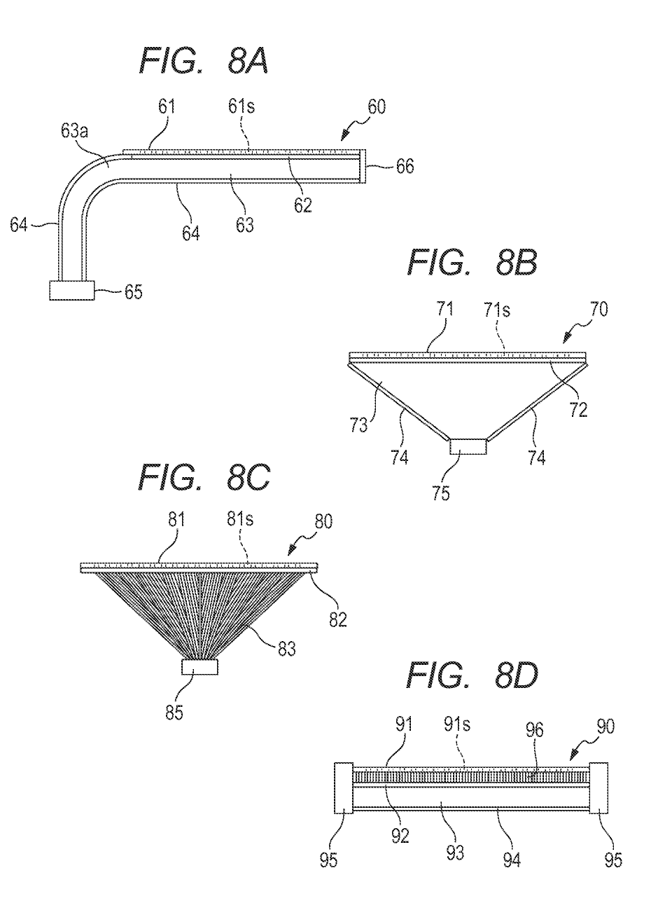

In the optical inspection apparatus 1 of this embodiment, the light guide 13 has a rod shape. The configuration is not limited thereto. For instance, as illustrated in FIG. 8A, the light guide 63 may have a smoothly bent shape. In this case, the photo detector 60 includes: a slit plate 61 having slits 61s; a diffuser 62 provided in contact with the back of the plate; a light guide 63 having a rearward bent portion 63a; a diffusion film 64 formed on the front and back faces of the light guide 63. An optical sensor 65 is provided at one end of the light guide 63. A total reflection mirror 66 is provided at the other end.

In the optical inspection apparatus 1 of this embodiment, the light guide 13 has a rod shape. The configuration is not limited thereto. For instance, as illustrated in FIG. 8B, the light guide 73 may have a substantially trapezoidal prism. In this case, a photo detector 70 includes: a slit plate 71 having slits 71s; a diffuser 72 provided in contact with the back of the plate; a light guide 73 provided on the diffuser 72 in a manner where a wider base surface of this guide is in contact with the diffuser; and diffusion films 74 formed on the slopes of the light guide 73. An optical sensor 75 is provided on a smaller base surface of the light guide 73.

In the optical inspection apparatus 1 of this embodiment, the light guide 13 is made of a single-piece member. The configuration is not limited thereto. For instance, as illustrated in FIG. 8C, a light guide 83 may be made of bundle fibers which is a bundle of optical fibers. In this case, a photo detector 80 includes: a slit plate 81 having slits 81s; a diffuser 82 provided rearward in contact with the plate; a light guide 83 provided in contact at one end with the diffuser 82; and an optical sensor 85 provided at the other end of the light guide 83.

In the optical inspection apparatus 1 of this embodiment, the slit plate 81 is in contact with the diffuser 82. The configuration is not limited thereto. For instance, as illustrated in FIG. 8D, the slit plate 91 and the diffuser 92 may be apart from each other, and, for instance, bundle fibers 96 may be provided therebetween. In this case, the photo detector 90 includes: a slit plate 91 having slits 91s; bundle fibers 96 provided rearward in contact with the plate; a diffuser 92 provided rearward in contact with the fibers; and a light guide 93 provided in contact at a side with the diffuser 92. This detector further includes: a diffusion film 94 provided at the rear of the light guide 93; and optical sensors 95 provided at both the ends of the light guide 93.

### Second Embodiment

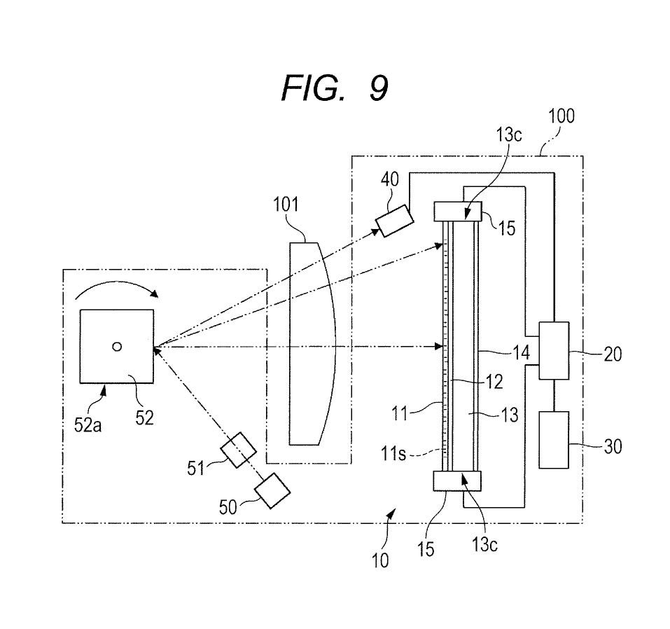

Next, an optical inspection system 100 according to a second embodiment of the present invention is described with reference to FIG. 9.

The optical inspection system 100 includes the optical inspection apparatus 1 of the first embodiment, and further includes the laser light source 50, the lens 51, and the rotary polygon mirror 52 included in the optical scanning apparatus 2. An inspection target is an optical component 101, such as an fθ lens, detachably attached between the rotary polygon mirror 52 and the photo detector 10. The optical component 101 can be attached and detached such that laser light from the laser light source 50 can be image-formed on a surface of the slit plate 11.

The optical inspection apparatus 1, the laser light source 50, the lens 51, and the rotary polygon mirror 52 have configurations equivalent to the configurations in the first embodiment. Accordingly, the same symbols are assigned to the equivalent components, and the detailed description thereof is omitted. The relationship between the pitch P of the slits 11s and the slit width W and the spot diameter D is equivalent to the relationship in the first embodiment.

The optical inspection system 100 of this embodiment can inspect the optical component 101, such as the fθ lens, only with this system as a single item. Accordingly, the optical component 101 including dust and stains can be preliminarily prevented from being incorporated into the optical scanning apparatus 2.

Thus, any one or a plurality of components among the laser light source 50, the lens 51, the rotary polygon mirror 52, and the optical component 101, such as the fθ lens, which are configurational elements of the scanning optical system 2, can be detachably provided in the first embodiment. Accordingly, each detachable configurational component as a single item can be inspected.

Furthermore, through use of the above-mentioned optical inspection apparatus, an optical scanning apparatus can be manufactured.

First, the above-mentioned optical inspection apparatus and the optical scanning apparatus as an inspection target are prepared. Subsequently, the optical inspection apparatus inspects the optical scanning apparatus, and then adjusts the optical scanning apparatus based on the inspection result, thereby allowing a high quality optical scanning apparatus to be manufactured.

According to the present invention, the multiple slits are provided on the slit plate at intervals in the direction where scanning with scanning light is performed. Therefore, one scan with spot light allows light reception at the multiple positions where slits are formed. Accordingly, time required for inspection can be reduced in comparison with the case where light is received while the photo detection unit having a single slit is moved for each scan with scanning light.

Furthermore, according to the present invention, the diffuser is provided between the slit plate and the light guide. Accordingly, even in the case where light incident on some slits among the slits obliquely enters the slit plate, the oblique incident light can be diffused by the diffuser and enter the light guide. Accordingly, the light quantity of the incident light that obliquely enters the slit plate and is reflected by the surface of the light guide not to enter the light guide can be reduced, and the light quantity received by the optical sensor can be increased. Thus, the inspection accuracy can be improved.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-046250, filed Mar. 8, 2013, which is hereby incorporated by reference herein in its entirety.

What is claimed is:

1. An optical inspection apparatus inspecting an optical system of an optical scanning apparatus by measuring a light quantity of scanning light emitted from the optical scanning apparatus, comprising:
a slit plate that has a plurality of slits;
a diffuser that diffuses the scanning light having passed through the slit;
a light guide that guides the scanning light diffused by the diffuser;
an optical sensor that measures a light quantity of the scanning light guided by the light guide; and
an inspection device that inspects a state of the optical system by comparing a measurement result acquired by the optical sensor with a preset reference value,
wherein the slits are arranged at intervals in a range including a scanning effective portion in a scanning range for the scanning light emitted from the optical scanning apparatus in a direction where scanning on the slit plate with the scanning light is performed.

2. The optical inspection apparatus according to claim 1, wherein the slits are arranged for each unit for inspection, and a length of the unit for inspection is a length of a spot diameter of the scanning light on the slit plate.

3. The optical inspection apparatus according to claim 1, wherein the light guide has a rod-like shape, the slit plate is arranged on a side of the light guide, and the optical sensor is provided on at least one end face of the light guide.

4. The optical inspection apparatus according to claim 1,
wherein a pitch at which the slits are arranged is P, an aperture width in a scanning direction on the slit is W, a spot diameter of the scanning light on the slit plate is D, and relationships
0.3<W/D<0.7
in a case where P>D, and
0.3<W/P<0.7
in a case where P≦D are satisfied.

5. An optical inspection system, comprising:
an optical scanning apparatus that includes a light source, and a rotary polygon mirror deflecting and reflecting light emitted from the light source as scanning light toward a slit plate; and
the optical inspection apparatus according to claim 1.

6. The optical inspection system according to claim 5, wherein an optical component that image-forms, on the slit plate, the scanning light deflected and reflected by the rotary polygon mirror is provided between the rotary polygon mirror and the slit plate, and the optical component is inspected by the optical inspection apparatus.

7. A method of manufacturing an optical scanning apparatus, comprising:
preparing an optical inspection apparatus according to claim 1, and the optical scanning apparatus;
inspecting the optical scanning apparatus using the optical inspection apparatus; and
adjusting the optical scanning apparatus based on a result of the inspecting.
